(19) United States
(12) Patent Application Publication
(10) Pub. No.: US 2004/0206222 A1
(43) Pub. Date: Oct. 21, 2004

(54) Film cutter with guiding mechanism

(76) Inventor: Kuo-Chen Chuang, Taoyuan Hsien (TW)

Correspondence Address: TROXELL LAW OFFICE PLLC, SUITE 1404, 5205 LEESBURG PIKE, FALLS CHURCH, VA, 22041, US

(21) Appl. No.: 10/418,175

(22) Filed: Apr. 18, 2003

(51) Int. Cl. B27B 13/02; B27B 33/14; B23D 57/00; B26D 1/12; B27B 33/02; B26D 5/08

(52) U.S. Cl. 83/614; 83/835; 83/666; 83/848

(57) ABSTRACT

Provided with a film cutter that has a guiding mechanism in accordance with the present invention includes a housing providing a pair of guiding rails thereon. The housing is adapted to be mounted on a box containing a film roll. The housing includes at least a receiving slot arranged adjacent to the guiding mils. At least a film positioning element is arranged in the receiving slot for providing a robust positioning of the film spans thereover and a cutter assembly moveably supported by the guiding rails for separating the film spans over the rails. When the film from the film roll is tightly stretched by the film-positioning elements thereby providing a clean cut when the cutter assembly slides over the stretched film.

### FIELD OF THE INVENTION

The present invention relates to a film cutter, and more particularly to a film cutter with guiding mechanism which includes a film-positioning element on which the film to be cut is securely positioned, thereby facilitating a clean cut.

### BACKGROUND OF THE INVENTION

In general a commercial cutting device for thin and flexible articles, especially to those cutting device for plastic food wrap or film that is highly flexible, is comprised of a guiding rail assembly made of plastic material. This guiding rail assembly can be an individual device attachable to a box containing the food wrap, or it can be integrally formed together with the box. A cutting assembly having a cutter or knife is built in the guiding device and moveably along the guiding rail unilateral or bilateral. By this arrangement, the food wrap span over the guiding device is then separated from its roll when the cutter slides over.

Generally speaking, the commercially available cutting devices for food wrap encounter a common difficult, especially on the guiding rail. Since the guiding rail is integrally injected from hard plastic, as a result the injected guiding rail is a kind of brittle, thereby losing its original attachable capability. Accordingly, in order to make the food wrap easily separate from the roll, the guiding rail has to be securely positioned by means of the components built in the box or by the roller built in the cutting assembly. When doing so, the food wrap spanning over the guiding rail is tightly stretched so as to make a clean cut. However, this arrangement is too complicated to make customer affordable because of the high manufacturing and molding cost. In addition, the assembling processes are too complicated to have a poor yield.

U.S. Patent Publication Nos. US2002/0023526A1 and US2002/0117038A1 disclose a film cutter assembly in which the cutter assembly is injection molded by two different plastic materials, a flexible plastic material which is located in upper position so as to provide a robust contact with the highly flexible film, and a harden plastic material which is located in the lower position so as to firmly support the cutting assembly. It does work, however it can be realized only by high accuracy and sophisticated control of synchronized injection of two different materials. In addition, the injection apparatus is quite expensive as well. The reason is when you put two different plastic materials, each having a certain viscosity as well as flow dynamics, into a common mold cavity, it is really a challenge to control those two different plastic flows to correctly deposit into its intended position. If the plastic flows are now correctly controlled with then mixed up together randomly, the upper portion of the assembly may suffer poor flexibility, while the lower portion may encounter poor rigidity. As a result, the cutter assembly cannot be properly supported when it slides over. On the other hand, if the food wrap is not securely positioned over the assembly and it is not tightly stretched, it will not have a clean cut.

### SUMMARY OF THE INVENTION

The present invention of film cutter with guiding device comprises the following:

A pair of guiding rails, having a platform, providing a connection space with a film container box, extending upwards from the platform, which is a formation of a horizontal film platform, also providing at least a receiving slot, and a guide rail, to facilitate assembly and slide of a cutting assembly;

At least an adhesive soft flexible component embedded in the film platform;

A cutting element fixed with a double-edged cutting blade;

The assembly of the flexible components at the end face of the film platform provides adhesiveness to the entire rail, the properties of the material of the wrapping film creating proper adhesive function to enable proper positioning of the film and smooth coordination with the control of cutting element in cutting the fi without resulting in sliding the wrapping film along the cutting element, which in return results in folding up the film and interference with the cutting process.

### BRIEF DESCRIPTION OF DRAWINGS

FIG. 1 is an assembled view of a film cutter in accordance with the present invention;

FIG. 2 is an exploded view of FIG. 1;

FIG. 3 is a cross sectional view of FIG. 1;

FIG. 4 is similar to FIG. 3 with a film positioned thereon; and

FIG. 5 is an illustration showing that the positioned film is separated.

### DETAILED DESCRIPTION OF PREFERABLE EMBODIMENT

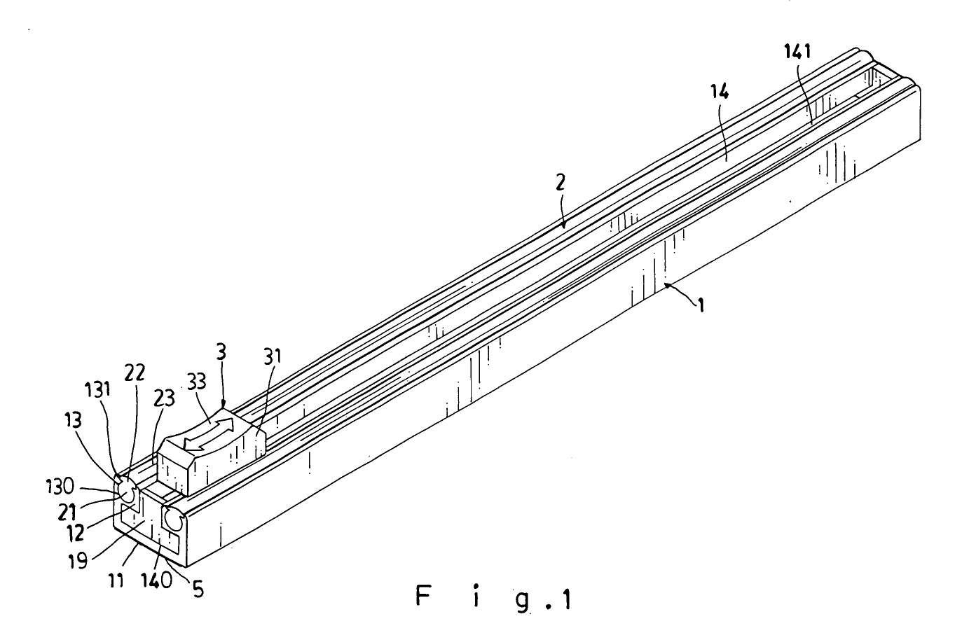

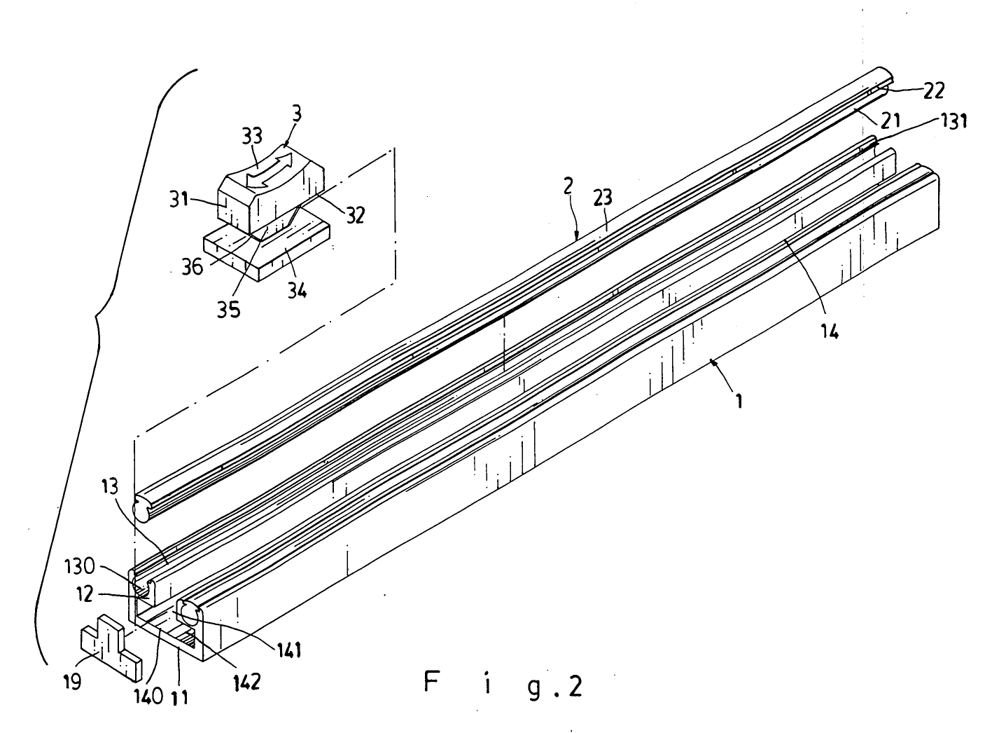

Referring to FIGS. 1 and 2, a film cutter in accordance with the present invention includes a guide rail housing on which a pair of guiding rails 1 is provided. The guide rail housing can be easily mounted onto box 4 in which a film roll is contained A pair of soft film-positioning elements 2 is arranged adjacent to the guiding rails 1 so as to provide a robust positioning of the film spanned thereover. A cutter assembly 3 is moveably supported by the guiding rails 1, which is clearly shown in FIG. 2.

The guide rail housing 1 includes platform 11 having an elongated and rectangular shape. The platform 11 has a planar bottom face so as to be easily and securely positioned over box 4 containing the film roll by means of a fixture 5. The guide rail film 1 further provides a film platform 12 on which the film 41 is tightly stretched. The film platform 12 is further provided with a pair of receiving slots 13 arranged next to a pair of guide rails 14. The guide rails 14 is arranged between platform 11 and film platform 12. The guide rails 14 include an upper portion 141 and a lower portion 142 interlocking each other.

The platform 11 and the film platform 12 are integrally formed through an injection molding process by means of hardened plastic material. As a result, the guiding rail housing 1 provides a robust working space, and its entirety can be firmly supported on the guide ail housing 4. A stopper 19 is used to enclose openings 140 located at the ends of guide rails 14. As a result, the cutter assembly 2 will not escape from the guide rails 14, while moving between the stoppers 19 along the guide rails 14.

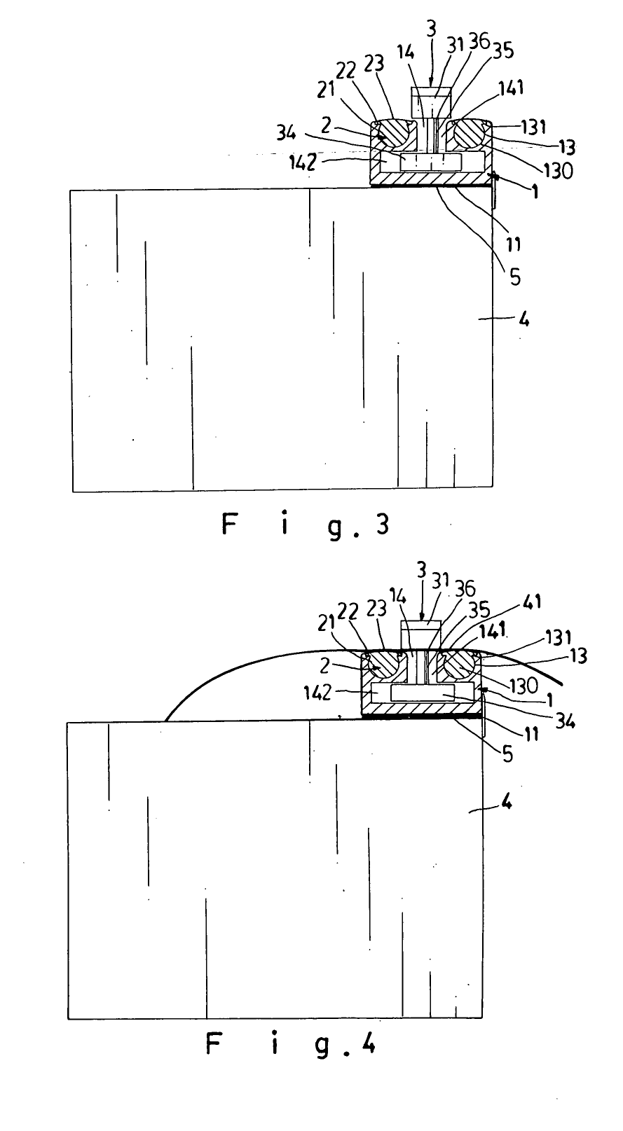

The receiving slot 13 defined in the film platform 12 is specially designed to have a dual-step slot configuration so as to provide a larger retaining contact area with respect to the film-positioning element 2, and also provide a larger supporting surface area with respect to film 41, as shown in FIGS. 2 and 3. Of course, other suitable slot configuration can be adopted. The receiving slot 13 includes a first slot portion 130 having a semi-circular configuration, which has a better retaining result; and a second slot portion 131, which closes to an opening of the receiving slot 13. The dimension of the second slot portion 131 is larger than a diameter of the first slot portion 130 so as to provide a larger exposing surface area for the film-positioning element 2. By this arrangement, the film 41 can be securely positioned over the film-positioning element 2.

The film-positioning element 2 can be securely retained within the receiving slot 13 defined in the film platform 11. The film-positioning element 2 is configured to have a similar configuration of the receiving slot 13. The film-positioning element 2 includes a first block member 21, which matches to the first slot portion 131, and a second block member 22 having a larger dimension over the first block member 21. The second block member 22 has a curve top surface 23 so as to increase the surface contacting area with respect to film 41. Of course other surfaces are also acceptable as long as film 41 can be securely positioned thereon.

The film-positioning element 2 is injection molded so as to have an elongated shape. It is preferable to mold the film-positioning element 2 by polyethylene. It is preferable to use PVC. Since the film-positioning element 2 is made from soft plastic material, it inherits a sticky property, which will not permanently attach. However, it is sticky enough to securely position film 41 thereon, thereby providing an excellent positioning characteristic.

The cutter assembly 3 includes base 31, providing a first space 32 for mounting a knife 35 therein. The base 31 forms a straddle 33 for manipulation of the cutter assembly 3. The first space 32 is arranged between the upper portion 141 of the guide rails 14. The knife 35 having dual-cutting edges 36. Accordingly, when base 31 slides over the guide rails 14, the film 41 is easily separated. A slide 34 is arranged below the first space 32. The slide 34 is integrally formed and dimensioned to fit into the lower portion 142 of the guide rails 14 of the guide rail housing 1. By this arrangement, the cutter assembly 2 slides smoothly and easily within guide rails 14.

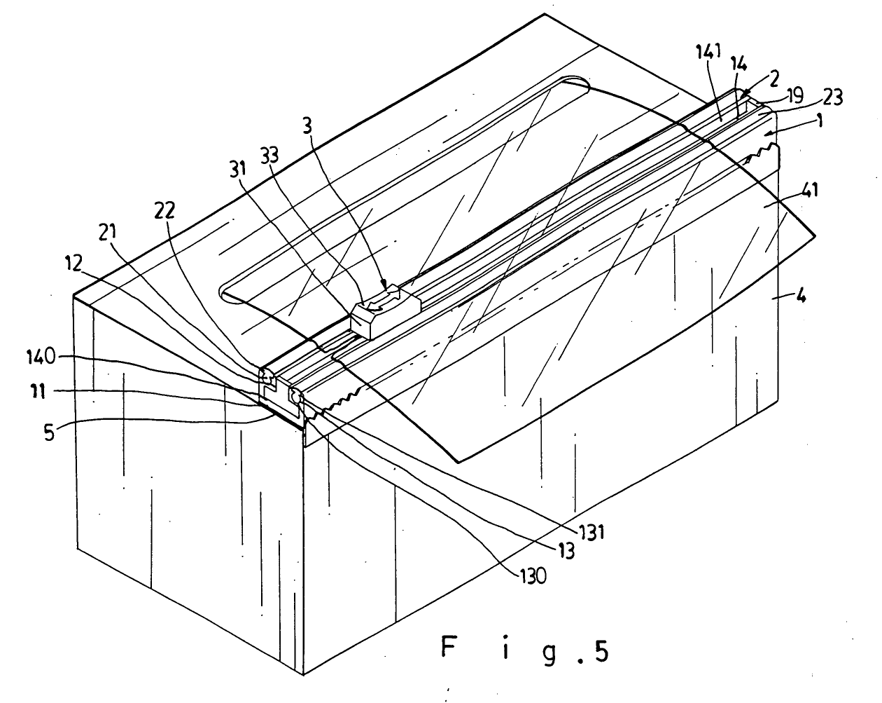

Referring to FIGS. 3 to 5, the guide rail housing 1 in accordance with the present invention can be easily mounted over box 4 having film 41 contained therein through platform 11 by means of fixture 5. It is preferably that guide rail housing 11 is closer to a built-in cutting saw of box 4, as shown in FIG. 3. As a result, the cutting saw can be perfectly blocked by the guide rail housing 1 so as to prevent the user from being injured by the cutting saw. Afterwards, film 41 is pulled out to the intended length from box 4 and spans over the guide rails 14 such that film 41 is securely rested onto the film platform 12 of the guide rail housing 1. By doing so, the film 41 is securely positioned over the film platform 11 by the film-positioning element 2, as shown in FIG. 4. Then the cutter assembly 3 can be moved so as to slide from one end to the other end of the guide rail housing 1. As a result, film 41, which spans over guide rails 14, is perfectly separated by cutting edge 36 of knife 35, as shown in FIG. 5. Even after cut film 41 is removed, the leading edge of film 41 from the film roll in box 4 is still positioned by film-positioning element 2 of the guide rail housing 1. This facilitates an easy draw of film 41 from the box each time the user wants to use it.

By the provision of the cutter assembly m accordance with the present invention, guide rail housing 1 can be easily manufactured without the sophisticated dual-material injection technique as well as apparatus. Guide rail housing 1 can be easily assembled while soft film-positioning element 2 provides a robust positioning of film 41. The defects of randomly mixing the two materials can be perfectly solved by the present invention. As such, the cutter assembly provides a film-positioning element 2 to securely position film 41 over film platform 11 while cutter assembly 3 can smoothly slide over to cut The cost is down, while the yield is increased, and the assembly is simplified as well. However, all of these mentioned can never be achieved by the prior art.

It is to be understood, however, that even though numerous characteristics and advantages of the present invention have been set forth in the foregoing description, together with the details of the structure and function of the invention, the disclosure is illustrative only, and changes may be made in detail especially in matters of shape, size and arrangement of parts within the principles of the invention to the full extent indicated by the broad general meaning of the terms in which the appended claims are expressed.

1-11. (Canceled)

12. A film cutter for cutting film and comprising:
a) a guide rail housing having:
i) a base;
ii) a film platform connected to the base and having two receiving slots; and
iii) two guide rails, each of the two guide rails located adjacent to one of the two receiving slots;
b) two soft film-positioning elements having a sticking property, one of the two soft film-positioning elements located in each of the two receiving slots; and
c) a cutter assembly slidably inserted between the two guide rails and having:
i) a handle;
ii) a slide; and
iii) a knife located between the handle and the slide and having dual cutting edges,
such that, when the film is positioned across the two soft film-positioning elements, the film is cut by sliding the cutter assembly along the two guide rails.

13. The film cutter according to claim 12, wherein each of the two receiving slots includes a first slot portion and a second slot portion, each of the two soft film-positioning elements includes a first block member and a second block member, each first block member is inserted into one first slot portion, and each second block member is inserted into one second slot portion.

14. The film cutter according to claim 13, wherein the second block member of each of the two soft film-positioning elements has a curved top surface.

15. The film cutter according to claim 12, further comprising two stoppers, one stopper located between the two guide rails on opposing ends of the guide rail housing.

16. The film cutter according to claim 12, wherein the two guide rails having a rail opening there between, the rail opening including an upper portion and a lower portion, the slide of the cutter assembly is located in the lower portion of the rail opening, the knife of the cutter assembly is located in the upper portion of the rail opening.

17. The film cutter according to claim 12, wherein the guide rail housing is made of a thermoplastic.

18. The film cutter according to claim 12, wherein the film positioning elements are made of a thermoplastic polyethylene.

19. The film cutter according to claim 18, wherein the thermoplastic polyethylene is polyvinyl chloride.

20. The film cutter according to claim 12, wherein the base of the housing has a planar bottom surface secured to a box containing a roll of film.
